(19) United States
(12) Patent Application Publication
(10) Pub. No.: US 2011/0135206 A1
(43) Pub. Date: Jun. 9, 2011

(54) Motion Extraction Device and Program, Image Correction Device and Program, and Recording Medium

(75) Inventors: Kenjiro Miura, Hamamatsu-shi (JP); Kenji Takahashi, Hamamatsu-shi (JP)

(73) Assignee: National University Corporation Shizuoka Universit

(21) Appl. No.: 12/999,828

(22) PCT Filed: Jun. 22, 2009
(86) PCT No.: PCT/JP2009/061329

§ 371 Date: Feb. 15, 2011

(30) Foreign Application Priority Data
Jun. 20, 2008 (JP) 2008-162477

(51) Int. Cl. G06K 9/46

(52) U.S. Cl. 382/201

(57) ABSTRACT

An image correction device is provided with a CPU (22). The CPU (22) calculates the square values of the differences between pixel values of a transformed frame image Iⁿ⁺¹ and pixel values of a frame image Iⁿ at the identical coordinates thereof each time predetermined values are set in the amount of translation and the amount of rotation, respectively, and a first transform frame image is generated; integrates the square values corresponding to all identical coordinates, where at least the transformed frame image Iⁿ⁺¹ and the frame image Iⁿ overlap, so as to derive the error function; searches for the minimum value of the derived error function by using the Broyden-Fletcher-Goldfarb-Shanno (BFGS) method; and extracts the affine transform parameters, which are obtained at the minimum value of the error function, as the amount of change of the frame image Iⁿ⁺¹ relative to the frame image Iⁿ.

### TECHNICAL FIELD

The present invention relates to a motion extraction device and program, an image correction device and program, and a recording medium.

### BACKGROUND ART

Due to the recent progress regarding integration techniques, video cameras have become compact and cheap. Thus, generally, the video cameras have come into widespread use, and are used in various places. Particularly, in recent years, in order to promptly collect information at the time of disaster, small-size video cameras are mounted on, for example, remote-control rescue robots such as a robot for searching for victims of disaster in a location where people cannot approach and an unmanned helicopter for checking the disaster situation from the air.

However, the robot equipped with a video camera may vibrate by itself or may run on a rough road surface or in a situation in which obstacles are scattered by earthquake. Hence, shaking occurs in the video sent from the camera mounted on the robot.

For this reason, it is difficult for an operator to judge the situation in that moment, and thus the shaking is likely to have an influence on the operation based on the screen-sick. Accordingly, in order to suppress the influence caused by the shaking of the video, it is necessary to reduce the shaking of the video by performing moving image processing in real time.

For digital cameras, examples of methods currently developed and studied for reducing the shaking include hand shake correction functions of an electronic type, an optical type, an image sensor shift type, a lens unit swing type, and the like. However, such a correction function is provided in a camera, and thus only the video taken by the camera can be corrected. This causes an increase in the size and cost of cameras.

Recently, as digital cameras have become popular and personal computers (PCs) have developed, even in general home PCs, moving image processing and the like can be easily performed. Accordingly, in order to improve the versatility thereof, there is a demand for stabilization processing using a PC. However, since the moving images have a large volume of data, when the images are processed, there is a large load on the CPU (Central Processing Unit). Thus, it is difficult to perform processing in real time.

For this reason, a method of using a GPU (Graphics Processing Unit), which is graphics hardware for high-speed graphics processing, can be considered. The GPU is mounted in a general PC, and is able to perform high-speed computing using parallel processing. The processing performance of the GPU, particularly, the floating-point calculation performance thereof may be equal to or more than 10 times that of the CPU.

The inventors of the present application disclose “video stabilization using a GPU” as a shake correction technique using a GPU (refer to Non-Patent Document 1). The technique disclosed in Non-Patent Document 1 is for correcting the shaking of the video on the basis of the global motion which is estimated by using a Broyden-Fletcher-Goldfarb-Shanno (a BFGS method, a quasi-Newton method) algorithm when performing global motion estimation using affine transformation.

[Non-Patent Document 1] Fujisawa and two others, “Video stabilization using a GPU”, Information Processing Society of Japan, information Processing Society Journal Vol. 49, No. 2, p. 1-8

### DISCLOSURE OF THE INVENTION

### Technical Problem

However, in the technique described in Non-Patent Document 1, the convergence time is long, and the number of calculation of the BFGS method becomes larger. Hence, it takes time to estimate the global motion, that is, the amount of change. For this reason, in the technique of Patent Document 1, only 4 to 5 frame images among 30 frame images per one second can be subjected to the shake correction processing, and thus in practice it is difficult to correct shaking of the moving image in real time.

The invention is contrived in order to solve the above-mentioned problem.

### Solution to Problem

According to a first aspect of the invention, an image change extraction device includes: an image transformation section that generates a first transform frame image by performing image transform processing on a first frame image among plural frame images constituting a moving image on the basis of affine transform parameters including an amount of translation and an amount of rotation; an error function derivation section that, whenever the image transformation section sets predetermined values respectively in the amount of translation and the amount of rotation and generates the first transform frame image, calculates square values of differences between pixel values of the first transform frame image, which is generated by the image transformation section, and pixel values of a second frame image, which is different from the first frame image among the plural frame images constituting the moving image, at identical coordinates thereof, and integrates the square values corresponding to all identical coordinates, in which at least the first transform frame image and the second frame image overlap, so as to derive an error function; and a change extraction section that searches for a minimum value of the error function, which is derived by the error function derivation section, by using a BFGS method, and extracts affine transform parameters, which are obtained at the minimum value of the error function, as an amount of change of the first frame image relative to the second frame image.

Whenever predetermined values are respectively set in the amount of translation and the amount of rotation and the first transform frame image is generated, the image change extraction device integrates the square values corresponding to all identical coordinates, where at least the first transform frame image and the second frame image overlap, so as to derive the error function. Then, the image change extraction device searches for the minimum value of the derived error function by using the BFGS method, and extracts the affine transform parameters, which are obtained at the minimum value of the error function, as the amount of change of the first frame image relative to the second frame image. Accordingly, it is possible to remarkably shorten the search time, and thus it is possible to extract the amount of change of the first frame image relative to the second frame image in real time.

According to a second aspect of the invention, an image correction device includes: the image change extraction device; and a correction section that performs correction processing on the first frame image so as to decrease the difference between the first frame image and the second frame image on the basis of the first frame image and an amount of change which is extracted by the image change extraction device.

According to a third aspect of the invention, an image correction device includes: the image change extraction device; and a correction section that performs correction processing on the second frame image so as to decrease the difference between the first frame image and the second frame image on the basis of the second frame image and an amount of change which is extracted by the image change extraction device.

By using the amount of change of the image extracted in real time, the image correction devices are able to correct, in real time, the image in accordance with the amount of change.

### Advantageous Effects of Invention

The image change extraction device and program according to one aspect of the invention integrate the square values corresponding to all identical coordinates, where at least the first transform frame image and the second frame image overlap, so as to derive the error function; search for the minimum value of the derived error function by using the BFGS method; and extract the affine transform parameters, which are obtained at the minimum value of the error function, as the amount of change of the first frame image relative to the second frame image. Thereby, it is possible to shorten the search time at the minimum value of the error function, and thus it is possible to extract the amount of change of images constituting the moving image in real time.

The image correction device and program according to one aspect of the invention extract the amount of change of the images constituting the moving image in real time, and are thereby able to correct, in real time, the image in accordance with the amount of change.

### BRIEF DESCRIPTION OF DRAWINGS

FIG. 1 is a block diagram illustrating a configuration of an image correction device according to an embodiment of the invention.

FIG. 2 is a diagram illustrating global motion estimation.

FIG. 3 is a diagram illustrating an amount of movement relative to the number of frames before and after correction (the state where correction is completed by the image correction device), where FIG. 3(A) shows an amount of movement in an X direction and FIG. 3(B) shows an amount of movement in a Y direction.

FIG. 4 is a diagram illustrating a synthesized image which is generated by synthesizing first to third frame images.

### BEST MODE FOR CARRYING OUT THE INVENTION

Hereinafter, preferred embodiments of the invention will be described in detail with reference to the accompanying drawings.

### First Embodiment

### Configuration of Image Correction Device

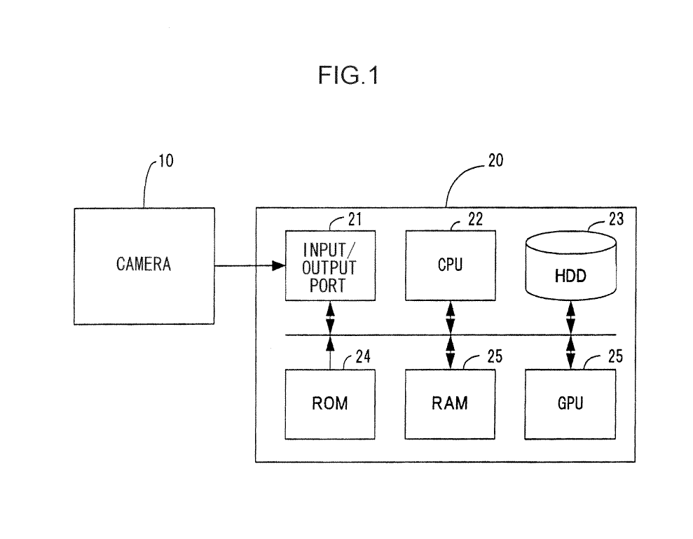

FIG. 1 is a block diagram illustrating a configuration of an image correction device according to an embodiment of the invention. The image correction device includes a camera 10 that generates an image by capturing a subject and an image processing device 20 that performs image processing so as to eliminate shaking of the image caused by the camera 10.

The image processing device 20 includes: an input/output port 21 that exchanges signals with the camera 10; a CPU (Central Processing Unit) 22 that performs calculation processing; a hard disk drive 23 that stores images and other data; a ROM (Read Only Memory) 24 that stores a control program of the CPU 22; a RAM (Random Access Memory) 25 that is a work area of the data; and a GPU 26 (Graphics Processing Unit) that performs predetermined calculation processing for image processing.

When receiving a moving image from the camera 10 through the input/output port 21, the CPU 22 sequentially transfers the moving image to the GPU 26, allows the GPU 26 to perform the predetermined calculation processing, and calculates an amount of movement of the camera 10 for each one frame from frame images constituting the moving image (global motion estimation). In the embodiment, it is assumed that the motion of the camera 10 of which vibration is eliminated is gentle and smooth. In addition, on the basis of the calculated amount of movement of camera 10, the CPU 22 corrects the vibration in each frame image.

### Global Motion Estimation

In order to stabilize a video, it is necessary to estimate global motion. When the motion between adjacent frames is obtained from the continuous frames, it is possible to estimate the motion of camera 10.

When the transformation between adjacent frame images Iⁿ and Iⁿ⁺¹ is assumed to be an affine transformation, the change in pixel coordinates x=(x, y) can be represented by Expression (1).

$$\begin{matrix}Numerical Expression 1 & \\ {x}_{n + 1} = ( \begin{matrix}{a}_{1} & {a}_{2} \\ {a}_{3} & {a}_{4}\end{matrix} ) ( \begin{matrix}{x}_{n} \\ {y}_{n}\end{matrix} ) + ( \begin{matrix}{b}_{1} \\ {b}_{2}\end{matrix} ) = {A}_{n} {x}_{n} + {b}_{n} & ( 1 )\end{matrix}$$

Further, Expression (1) can be changed into Expression (2).

$$\begin{matrix}Numerical Expression 2 & \\ \begin{matrix}{x}_{n} = {A}_{n - 1} {x}_{n - 1} + {b}_{n - 1} = … \\ = [ {\prod }_{k = n}^{1} {A}_{k - 1} ] {x}_{1} + {\sum }_{k = 1}^{n} [ {\prod }_{m = n}^{k + 1} {A}_{m - 1} ] {b}_{k} = {\tilde{A}}_{n} {x}_{1} + {\tilde{b}}_{n}\end{matrix} & ( 2 )\end{matrix}$$

Expression (2) represents motion of the camera 10 on the basis of optional frames. Affine transform parameters can be represented by Expression (3).

(Aₙⁿ⁺¹,bₙ⁺¹) Numerical Expression 3

This expression can be obtained by calculating the minimum value Eₘᵢₙ of an error function of the following Expression (3).

$$\begin{matrix}Numerical Expression 4 & \\ E ( {I}^{n} , {I}^{n + 1} , {A}_{n}^{n + 1} , {b}_{n}^{n + 1} ) = {\sum }_{x ∈ χ} {( {I}^{n} ( {x}_{n} ) - {I}^{n + 1} ( {A}_{n}^{n + 1} {x}_{n} + {b}_{n}^{n + 1} ) )}^{2} & ( 3 )\end{matrix}$$

χ represents all coordinates on the screen plane. Expression (3) is the sum of each squared difference between brightness values of two frame images. Here, the error function described in Non-Patent Document 1 is compared with the following expression.

$$\begin{matrix} Numerical Expression 5 \\ E ( {I}^{n} , {I}^{n + 1} , {A}_{n}^{n + 1} , {b}_{n}^{n + 1} ) = {\sum }_{x ∈ χ} \sqrt{( {I}^{n} ( {x}_{n} ) - {I}^{n + 1} ( {A}_{n}^{n + 1} {x}_{n} + {b}_{n}^{n + 1} ) ) + β}\end{matrix}$$

The above-mentioned error function is used to acquire the absolute difference between the brightness values of the frames in the calculation of the differences between the frames.

If the absolute value of the above-mentioned expression is calculated (β→0), from the expression before the summation, the absolute value of the difference image between frames is precisely acquired. However, since the expression includes the root term, its calculation takes a very long time.

For this reason, in Expression (3) of the embodiment, root calculation and β are omitted. Expression (3) is the sum of each squared difference between the frames, and represents one different from the difference image. That is, even when Expression (3) is calculated, only an image which is not meaningful to the human eye can be obtained.

Originally, global motion meant motion of the entirety which can be seen by the human eye. Accordingly, as described in Non-Patent Document 1, it is naturally inferred that the error function is an integrated value of differences between pixel values obtained when images are precisely overlapped and matched.

In contrast, in Expression (3) of the embodiment, it would appear that Expression (3) is a simple square expression and, in some special cases, may have a solution the same as the error function of Non-Patent Document 1. On the other hand, by using the solution of Expression (3), it is possible to perform the vibration correction. That is, it can be observed that the error functions of Non-Patent Document 1 and the embodiment are defined to be different from each other but may have the same result. Accordingly, since Expression (3) of the embodiment is represented as the simple square expression, as the root calculation is omitted, the operation speed increases, and the differences increase. Thus, there are following advantages: convergence to the minimum value becomes more fast; and failure in global motion correction is reduced. Then, the CPU 22 and the GPU 26 of the image processing device 20 shown in FIG. 1 perform the following calculations.

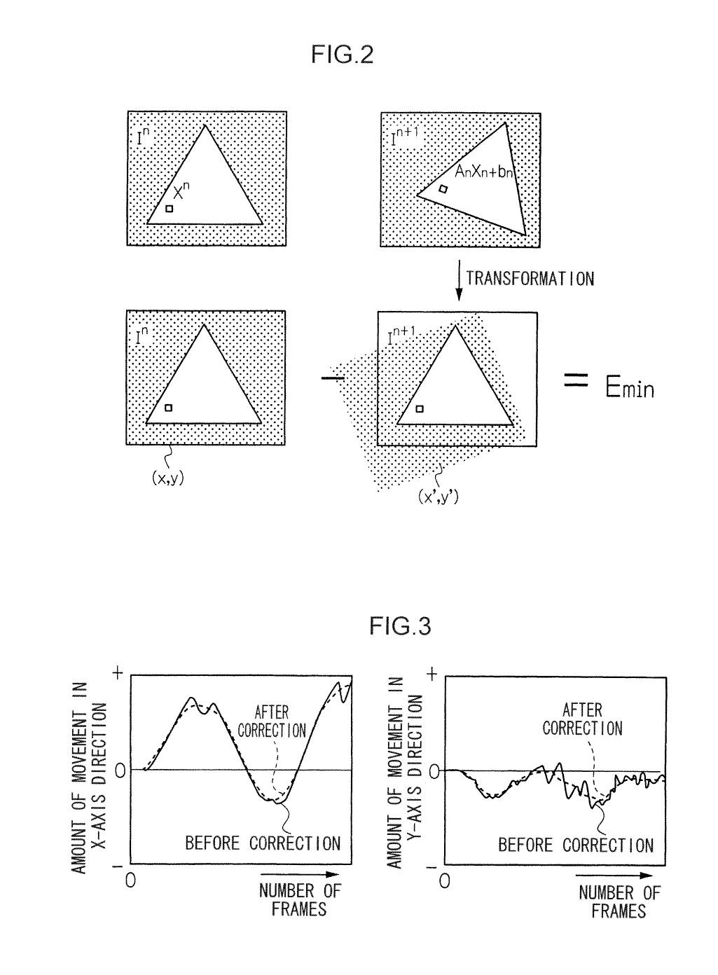

FIG. 2 is a diagram illustrating global motion estimation. Assuming that the frame image Iⁿ is a reference, the amount of shake of a camera is defined as an image movement amount (rotation angle θ, movement amounts b1 and b2 in respective xy directions) of the frame image Iⁿ⁺¹. The CPU 22 shown in FIG. 1 stores plural affine transform parameters which are provided in advance as candidates of the image movement amount of the frame image Iⁿ⁺¹, and thus transmits the plural affine transform parameters to the GPU 26 together with the frame image Iⁿ⁺¹. In addition, it is preferable that the frame image Iⁿ⁺¹ should be the latest frame in the moving image created by the camera 10.

In addition, the CPU 22 calculates an error value E when the affine transform parameters are used in the GPU 26, and extracts the affine transform parameters, which are obtained when the error value E is minimized, as the movement amount of the camera 10. It should be noted that the CPU 22 may perform calculation of sin θ and cos θ based on the rotation angle θ instead of transmission of the affine transform parameters (θ, b1, and b2) to the GPU 26 so as to transmit b₁, b₂, sin θ, and cos θ as the affine transform parameters to the GPU 26.

On the other hand, when receiving the affine transform parameters transmitted from the CPU 22, the GPU 26 performs transform processing on the frame image Iⁿ⁺¹ by using the above-mentioned affine transform parameters.

Specifically, the GPU 26 calculates the squared differences of the pixel values (the brightness values) at respective identical coordinates between the frame image Iⁿ and the transformed frame image Iⁿ⁺¹. In addition, the calculation of the squared differences of the brightness values is performed on all coordinates (for example, all coordinates in the region where at least the frame images Iⁿ and Iⁿ⁺¹ overlap each other). In addition, the GPU 26 calculates, in parallel and independently, the square values of the differences between the brightness values for the respective identical coordinates in the overlapping region. Thereby, the GPU 26 is able to perform calculation independently at the respective coordinates, and is able to achieve high-speed processing by performing the parallel calculation processing. Further, the GPU 26 integrates, in parallel, the squared differences of the brightness values for all coordinates, and obtains the integrated value as an error value. Here, it is preferable that the GPU 26 should integrate, in parallel, the squared differences of the brightness values to a certain degree, and then the CPU 22 should sequentially integrate the squared differences of the remaining brightness values, and sum the integrated values. Whenever the affine transform parameters are changed, the above-mentioned error value is calculated.

Meanwhile, when a pixel at coordinates (x′, y′) at the time of transforming the frame image Iⁿ⁺¹ corresponds to a pixel at coordinates (x, y) of the frame image Iⁿ, the difference between the brightness values thereof becomes equal to 0, and thus the error value decreases. As the error value is smaller, the number of corresponding pixels between frames is larger. As a result, the parameters (A, b) at that time represent motion between the frames.

The GPU 26 calculates the above-mentioned error value with respect to all affine transform parameters provided in advance, and then the CPU 22 selects affine transform parameters obtained when the error value becomes the minimum among all error values, and extracts the selected affine transform parameters as the motion between frames, that is, as the amount of movement of the camera.

In addition, the affine transformation at the pixel coordinates is represented as follows.

Aₙⁿ⁺¹xₙ+bₙⁿ⁺¹ Numerical Expression 6

On the basis of the above-mentioned expression, when referring to a region in which the brightness values are not defined (an undefined region: a region in which the frame images Iⁿ and Iⁿ⁺¹ do not overlap each other), the CPU 22 sets the differences of the brightness values of the pixels thereof to 0 in order to exclude the pixels thereof from the calculation of the error value. Then, by using the number of final effective pixels χₑ of the entire pixels the CPU 22 corrects the error value E as follows.

Ê=(χ/χₑ)E Numerical Expression 7

However, when α=χₑ/χ is small (for example, ¼), an incorrect result is likely to be produced. For example, even when actual motion of the camera 10 is small, sometimes an amount of change may be large at the beginning of iteration of a minimizing method, and the value of α may decrease. For this reason, in the embodiment, when α is less than ¼ (α<¼), the CPU 22 regards the difference between the brightness values of the pixels in the undefined region as 0, and performs calculation so as to intentionally increase the error value. When the difference between the brightness values is regarded as 0, it is preferable that a should be sufficiently smaller than 1, and it is not always necessary for α to be less than ¼.

For searching for the minimum value of the error function, the algorithm based on the BFGS method (the quasi-Newton method) of NUMERICAL RECIPES is used. The algorithm of the BFGS (Broyden, Fletcher, Goldfarb, Shanno) method searches for the minimal direction by using a function and a derivative, and thus the algorithm has a small number of calculations and a small convergence time. Since the BFGS method needs the derivative, in order to calculate the derivative, Expression (3) can be rewritten as the following Expressions (4) and (5).

$$\begin{matrix}Numerical Expression 8 & \\ E = {\sum }_{x ∈ χ} {( {I}^{n} ( {x}_{n} ) - {I}^{n + 1} ( {x}_{n + 1} ) )}^{2} = {\sum }_{x ∈ χ} Δ {I}^{2} & ( 4 ) \\ {x}_{n + 1} = ( {a}_{1} {x}_{n} + {a}_{2} {y}_{n} + {b}_{1} , {a}_{3} {x}_{n} + {a}_{4} {y}_{n} + {b}_{2} ) & ( 5 )\end{matrix}$$

The derivative obtained from the above expression is given by Expression (6).

$$\begin{matrix}Numerical Expression 9 & \\ \frac{\partial E}{\partial {a}_{1}} = {\sum }_{x ∈ χ} 2 Δ I \frac{\partial Δ I}{\partial {a}_{1}} & ( 6 )\end{matrix}$$

Further, the following Expression (7) is also established.

$$\begin{matrix}Numerical Expression 10 & \\ \frac{\partial Δ I}{\partial {a}_{1}} = \frac{\partial Δ I}{\partial {I}^{n - 1}} \frac{\partial {I}^{n - 1}}{\partial {x}_{n - 1}} \frac{\partial {x}_{n - 1}}{\partial {a}_{1}} = - 1 \frac{\partial {I}^{n - 1}}{\partial {x}_{n - 1}} {x}_{n} & ( 7 )\end{matrix}$$

Accordingly, all derivatives are represented as the following Expressions (8) to (13).

$$\begin{matrix}Numerical Expression 11 & \\ \frac{\partial E}{\partial {a}_{1}} = - 2 {\sum }_{x ∈ χ} Δ I \frac{\partial {I}^{n - 1}}{\partial {x}_{n - 1}} {x}_{n} & ( 8 ) \\ \frac{\partial E}{\partial {a}_{2}} = - 2 {\sum }_{x ∈ χ} Δ I \frac{\partial {I}^{n - 1}}{\partial {x}_{n - 1}} {y}_{n} & ( 9 ) \\ \frac{\partial E}{\partial {b}_{1}} = - 2 {\sum }_{x ∈ χ} Δ I \frac{\partial {I}^{n - 1}}{\partial {x}_{n - 1}} & ( 10 ) \\ \frac{\partial E}{\partial {a}_{3}} = - 2 {\sum }_{x ∈ χ} Δ I \frac{\partial {I}^{n - 1}}{\partial {y}_{n - 1}} {x}_{n} & ( 11 ) \\ \frac{\partial E}{\partial {a}_{4}} = - 2 {\sum }_{x ∈ χ} Δ I \frac{\partial {I}^{n - 1}}{\partial {y}_{n - 1}} {y}_{n} & ( 12 ) \\ \frac{\partial E}{\partial {b}_{2}} = - 2 {\sum }_{x ∈ χ} Δ I \frac{\partial {I}^{n - 1}}{\partial {y}_{n - 1}} & ( 13 )\end{matrix}$$

Here, in Expressions (8) to (10), Expression (14) is established, and in Expressions (11) to (13), Expression (15) is established.

$$\begin{matrix}Numerical Expression 12 & \\ \frac{\partial {I}^{n - 1}}{\partial {x}_{n - 1}} = \frac{{I}^{n + 1} ( {x}_{n + 1} + Δ x , {y}_{n + 1} ) - {I}^{n + 1} ( {x}_{n + 1} - Δ x , {y}_{n + 1} )}{2 Δ x} & ( 14 ) \\ \frac{\partial {I}^{n - 1}}{\partial {y}_{n - 1}} = \frac{{I}^{n + 1} ( {x}_{n + 1} , {y}_{n + 1} + Δ y ) - {I}^{n + 1} ( {x}_{n + 1} , {y}_{n + 1} - Δ y )}{2 Δ y} & ( 15 )\end{matrix}$$

In the embodiment, in order to achieve high-speed processing, assuming that the motion of the image is only translation and rotation, the desirable affine transform parameters are set as three parameters of θ, b₁, and b₂, and then the affine matrix T is represented as Expression (16).

$$\begin{matrix}Numerical Expression 13 & \\ T = ( \begin{matrix}cos θ & sin θ & {b}_{1} \\ sin θ & cos θ & {b}_{2} \\ 0 & 0 & 1\end{matrix} ) & ( 16 )\end{matrix}$$

Further, the derivative is represented as the following Expressions (17) to (19).

$$\begin{matrix}Numerical Expression 14 & \\ \frac{\partial E}{\partial θ} = - 2 {\sum }_{x ∈ χ} Δ I ( \frac{\partial {I}^{n + 1}}{\partial {x}_{n + 1}} \frac{\partial {x}_{n + 1}}{\partial θ} + \frac{\partial {I}^{n + 1}}{\partial {y}_{n + 1}} \frac{\partial {y}_{n + 1}}{\partial θ} ) & ( 17 ) \\ \frac{\partial E}{\partial {b}_{1}} = - 2 {\sum }_{x ∈ χ} Δ I \frac{\partial {I}^{n + 1}}{\partial {x}_{n + 1}} & ( 18 ) \\ \frac{\partial E}{\partial {b}_{2}} = - 2 {\sum }_{x ∈ χ} Δ I \frac{\partial {I}^{n + 1}}{\partial {y}_{n + 1}} & ( 19 )\end{matrix}$$

Here, on the basis of the definition of Expression (*), the above expressions are rewritten as Expression (20) to (23).

$$\begin{matrix}Numerical Expression 15 & \\ Δ I = {I}^{n} ( {x}_{n} ) - {I}^{n + 1} ( {x}_{n + 1} ) & (* ) \\ {x}_{n + 1} = {x}_{n} cos θ - {y}_{n} sin θ + {b}_{1} & ( 20 ) \\ {y}_{n + 1} = {x}_{n} sin θ + {y}_{n} cos θ + {b}_{2} & ( 21 ) \\ \frac{\partial {x}_{n + 1}}{\partial θ} = - {x}_{n} sin θ - {y}_{n} cos θ & ( 22 ) \\ \frac{\partial {y}_{n + 1}}{\partial θ} = {x}_{n} cos θ - {y}_{n} sin θ & ( 23 )\end{matrix}$$

That is, the CPU 22 of the image processing device 20 shown in FIG. 1 defines the error function of Expression (3) by using the affine transform matrix of Expression (16), and uses the BFGS method, which is one of the quasi-Newton methods, in order to search for the minimum value of the error function. Here, in the BFGS method, the derivative is necessary. Accordingly, the CPU 22 searches for the minimum value of the error function of Expression (3) by using the derivatives of Expressions (17) to (19) (including Expressions (20) to (23)), finds the parameters (θ, b₁, and b₂) at the minimum value, and extracts the parameters as the image movement amount, that is, the amount of shake of the camera 10.

In the case of deriving the error function plural times, one error function is derived, and then the error function is derived again by using new affine transform parameters (in which at least one of θ, b₁, and b₂ is changed by a predetermined amount). In addition, the method of changing the parameters is not particularly limited. Further, as the BFGS method, it may be possible to use the method described in The Art of Scientific Computing: Teukolsky, S. A., Vetterling, W. T. and Flannery, B. P., Numerical Recipes in C++, Cambridge University Press (2002).

### Vibration Correction

In order to smooth the motion of the screen, it is necessary to find a transform matrix for correction based on the estimated global motion. The transform matrix S from the frame before correction to the frame after correction is obtained through the affine transformation from the k-th frame previous to the correction target frame to the k-th frame subsequent to the correction target frame. As a result, the transform matrix S is represented by the following Expression (24).

$$\begin{matrix}Numerical Expression 16 & \\ {S}_{n} = {\sum }_{m = n - k}^{n + k} {T}_{n}^{m} * G ( k ) & ( 24 )\end{matrix}$$

where

Tₙ^{m} Numerical Expression 17

is the affine transform matrix from frame n to frame m. Further,

$$G ( k ) = \frac{1}{\sqrt{2 πσ}} {e}^{- {k}^{2} / 2 {σ}^{2}} \qquad Numerical Expression 18$$

is a Gaussian kernel. The sign of * in Expression (24) represents a convolution operator. Further, √k=σ.

Then, by calculating the following Expression (25) through the obtained transform matrix, the CPU 22 of the image processing device 20 shown in FIG. 1 is able to perform vibration correction on the target frame images so as to decrease the difference between the frame images.

$$\begin{matrix}Numerical Expression 19 & \\ \begin{matrix}{\overline{x}}_{n} = {S}_{n} {x}_{n} \\ = {\hat{A}}_{n} {x}_{1} + {\hat{b}}_{n} \\ = ( {{\hat{A}}_{n} ( \tilde{A} )}_{n}^{- 1} ) {x}_{n} + ( {{\hat{A}}_{n} ( \tilde{A} )}_{n}^{- 1} ) {\tilde{b}}_{n} + {\hat{b}}_{n} \\ = {\overline{A}}_{n} {x}_{n} + {\overline{b}}_{n}\end{matrix} \} & ( 25 )\end{matrix}$$

Here, when the vibration correction is performed between frame images adjacent to each other, the above-mentioned n and m are continuous natural numbers. However, when the vibration correction of the predetermined frame image is performed as compared with the reference frame image, n and m may not be continuous natural numbers.

The inventors of the present application calculated the number of uses of the BFGS method per frame, and thus it was possible to obtain the following result. When the error function described in Non-Patent Document 1 is used, in the cases where the GPU performs the calculation, the number of uses thereof was 42.87 as an average, and in the cases where the CPU performs the calculation, the number of uses thereof was 11.43 as an average. In contrast, when the error function of Expression (3) of the embodiment is used, in the cases where the GPU performs the calculation, the number of uses thereof was 7.707 as an average, and in the cases where the CPU performs the calculation, the number of uses thereof was 6.481 as an average. Consequently, use of the error function of Expression (3) decreases the number of calculations, and thus it is possible to perform calculation in a short period of time.

FIG. 3 is a diagram illustrating an amount of movement relative to the number of frames before and after correction (the state where correction is completed by the image correction device), where FIG. 3(A) shows an amount of movement in an X direction and FIG. 3(B) shows an amount of movement in a Y direction. As shown in the drawing, each amount of movement is remarkably smoothed by correction.

Further, the CPU 22 of the image processing device 20 may sequentially synthesize frame images in which at least one of the amount of rotation and the amount of translation is corrected, and may generate the synthesized image formed of plural frames.

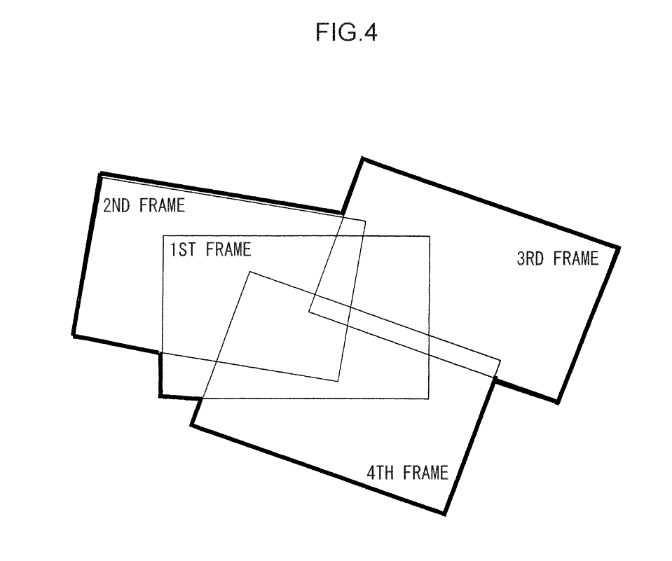

FIG. 4 is a diagram illustrating a synthesized image which is generated by synthesizing first to third frame images. Here, the CPU 22 sequentially overlaps the latest corrected frame images one upon another so as to level off the images at the center position thereof. In such a manner, the center portion thereof is formed of new frame images, and the peripheral portion thereof is formed of old frame images, thereby generating a synthesized image larger than each frame image.

In this case, the GPU 26 sets a flag for determining whether an image is present at respective coordinates, and may calculate the error function E only at the coordinates where the image is present. As a result, the estimation error in the amount of movement of the frame image is reduced. Thus, even if the latest frame image and the immediately previous frame image hardly overlap, the global motion estimation is possible. In addition, in order to prevent accumulated error, the GPU 26 may not synthesize the frame images, which are previous by predetermined frames to the latest frame image, and may sequentially delete them.

Moreover, the GPU 26 may set the synthesized image, which is generated by synthesizing the previous frame images Iⁿ, Iⁿ⁻¹, Iⁿ⁻², . . . , as the frame image Iⁿ, and may calculate the error function E by using the next latest frame image Iⁿ⁺¹. In such a manner, even when the amount of shake of the camera 10 is large, the overlapping range between the synthesized frame image Iⁿ and the next latest frame image Iⁿ⁺¹ increases. Therefore, the amount of shake of the camera is reliably detected.

As described above, the image correction device according to the embodiment of the invention is configured to search for the minimum value of the error function of Expression (3) by using the BFGS method. With such a configuration, as compared with the related art, the image correction device is able to find the affine transform parameters at the minimum value of the error function in a very short period of time, and correct shaking of the moving image in real time by using the affine transform parameters.

In the method of searching for the minimum value by using the BFGS method, the minimum value is searched by iteratively performing calculation plural times. Therefore, even a small difference in operation speed between the individual arithmetic expressions has a great influence on the final operation speed. In particular, since the image correction device according to the embodiment performs the calculation for each pixel of the image, and the difference is remarkable. In Non-Patent Document 1, each individual arithmetic expression includes the square root, and thus in most cases, the operation speed becomes low. In contrast, in the image correction device according to the embodiment, focusing on the error function, it is possible to search for the minimum value of the error function at a high speed without using calculation of the square root. Further, by using the error function, it is also possible to reduce the number of iterative calculations itself for searching for the minimum value using the BFGS method.

Moreover, the image correction device is able to generate a synthesized image having a larger size than that of the frame image by sequentially synthesizing the corrected frame images. In addition, the image correction device extracts the amount of movement of the latest frame image from the large-size synthesized image. Thereby, even when the amount of shake of the camera 10 is large, by reliably extracting the amount of shake, the image correction device is able to correct the shake.

In addition, in the image correction device, not only in the case where the camera 10 is shaken but also in the case where the subject is shaken, it is possible to correct the shaking of the subject in the moving image in real time by using the above-mentioned Expression (3).

### Second Embodiment

### Case of Using Other Affine Transform Parameters

Next, the second embodiment of the invention will be described. In addition, the elements common to the first embodiment will be represented by the same reference numerals and signs, and description thereof will be omitted.

In the first embodiment, the affine transform parameters (θ, b₁, and b₂) of 3 variables, are used, but in the second embodiment, the affine transform parameters (θ, b₁, b₂, and z) of 4 variables are used. In addition, z is a parameter of a zoom direction, and represents the scale of the image. Here, the error function is represented as the following Expression (26).

$$\begin{matrix}Numerical Expression 20 & \\ E ( n , n + 1 ) = {\sum }_{x ∈ χ} {( {I}^{n} ( {x}_{n} ) - {I}^{n + 1} ( {A}_{n}^{n + 1} {x}_{n} + {b}_{n}^{n + 1} ) )}^{2} & ( 26 )\end{matrix}$$

In Expression (26), χ is a set of all coordinates on the screen plane. I(x) is a brightness value of a pixel x. In addition, when the affine transform parameters of 4 variables are used, the affine transformation is represented as the following Expression (27).

$$\begin{matrix}Numerical Expression 21 & \\ {x}_{n + 1} = {A}_{n}^{n + 1} {x}_{n} = {b}_{n}^{n + 1} = ( \begin{matrix}cos θ & - sin θ \\ sin θ & cos θ\end{matrix} ) ( \begin{matrix}{x}_{n} \\ {y}_{n}\end{matrix} ) + ( \begin{matrix}{b}_{1} \\ {b}_{2}\end{matrix} ) & ( 27 )\end{matrix}$$

At this time, the derivatives are represented as Expressions (28) to (31).

$$\begin{matrix}Numerical Expression 22 & \\ \frac{\partial E}{\partial θ} = - 2 {\sum }_{x ∈ χ} Δ I ( \frac{\partial {I}^{n + 1}}{\partial {x}_{n + 1}} \frac{\partial {x}_{n + 1}}{\partial θ} + \frac{\partial {I}^{n + 1}}{\partial {y}_{n + 1}} \frac{\partial {y}_{n + 1}}{\partial θ} ) & ( 28 ) \\ \frac{\partial E}{\partial {b}_{1}} = - 2 {\sum }_{x ∈ χ} Δ I \frac{\partial {I}^{n + 1}}{\partial {x}_{n + 1}} & ( 29 ) \\ \frac{\partial E}{\partial {b}_{2}} = - 2 {\sum }_{x ∈ χ} Δ I \frac{\partial {I}^{n + 1}}{\partial {y}_{n + 1}} & ( 30 ) \\ \frac{\partial E}{\partial z} = - 2 {\sum }_{x ∈ χ} Δ I ( \frac{\partial {I}^{n + 1}}{\partial {x}_{n + 1}} \frac{\partial {x}_{n + 1}}{\partial z} + \frac{\partial {I}^{n + 1}}{\partial {y}_{n + 1}} \frac{\partial {y}_{n + 1}}{\partial z} ) & ( 31 )\end{matrix}$$

Here, the derivatives satisfy Expressions (32) to (38).

$$\begin{matrix}Numerical Expression 23 & \\ Δ I = {I}^{n} ( {x}_{n} ) - {I}^{n + 1} ( {x}_{n + 1} ) & ( 32 ) \\ {x}_{n + 1} = z {x}_{n} cos θ - z {y}_{n} sin θ + {b}_{1} & ( 33 ) \\ {y}_{n + 1} = z {x}_{n} sin θ + z {y}_{n} cos θ + {b}_{2} & ( 34 ) \\ \frac{\partial {x}_{n + 1}}{\partial θ} = - z {x}_{n} sin θ - z {y}_{n} cos θ & ( 35 ) \\ \frac{\partial {y}_{n + 1}}{\partial θ} = z {x}_{n} cos θ - z {y}_{n} sin θ & ( 36 ) \\ \frac{\partial {x}_{n + 1}}{\partial z} = {x}_{n} cos θ - {y}_{n} sin θ & ( 37 ) \\ \frac{\partial {y}_{n + 1}}{\partial z} = {x}_{n} sin θ + {y}_{n} cos θ & ( 38 )\end{matrix}$$

In the second embodiment, the CPU 22 of the image processing device 20 shown in FIG. 1 applies the BFGS method using Expressions (28) to (31) (including Expressions (32) to (38)) to the error function using the above-mentioned affine transform parameters of 4 variables. Thereby, the CPU 22 is able to search for the minimum value of the error value in a short period of time, thereby extracting the affine transform parameters at that time as the motion between frames, that is, as the amount of movement of the camera. Therefore, the CPU 22 is able to correct an image in the same manner as the first embodiment by using the affine transform parameters.

As described above, the image correction device according to the second embodiment is able to extract the amount of movement by using the affine transform parameters including the zoom direction parameter. Therefore, even when the camera 10 vibrates as the size of the subject displayed in the image is changed, it is possible to correct the moving image so as to suppress the vibration in real time.

Further, the invention is not limited to the above-mentioned embodiment, and it is apparent that various modifications in design may be made without departing from the scope of the appended claims. For example, in the above-mentioned embodiment, the transformation of the frame image Iⁿ⁺¹ adjacent to the frame image Iⁿ is represented by the affine transform parameters. However, the frame image to be transformed may not be adjacent to the frame image Iⁿ. For example, the prescribed frame image, which is separated by several frames from the reference frame image, may be represented as the affine transform parameters.

Further, in the above-mentioned embodiment, the image processing device 20 is able to correct, in real time, the moving image generated by the camera 10 while correcting the moving image which is stored in the hard disc drive 23 in advance in the same manner.

### EXPLANATION OF REFERENCES

10: CAMERA
20: IMAGE PROCESSING DEVICE
22: CPU
26: GPU

1. An image change extraction device comprising:
an image transformation section that generates a first transform frame image by performing image transform processing on a first frame image among a plurality of frame images constituting a moving image on the basis of affine transform parameters including an amount of translation and an amount of rotation;
an error function derivation section that, whenever the image transformation section sets predetermined values respectively in the amount of translation and the amount of rotation and generates the first transform frame image, calculates square values of differences between pixel values of the first transform frame image, which is generated by the image transformation section, and pixel values of a second frame image, which is different from the first frame image among the plurality of frame images constituting the moving image, at identical coordinates thereof, and integrates the square values corresponding to all identical coordinates, in which at least the first transform frame image and the second frame image overlap, so as to derive an error function; and
a change extraction section that searches for a minimum value of the error function, which is derived by the error function derivation section, by using a BFGS method, and extracts affine transform parameters, which are obtained at the minimum value of the error function, as an amount of change of the first frame image relative to the second frame image.

2. The image change extraction device according to claim 1,
wherein the image transformation section performs the image transform processing by using the affine transform parameters which include an amount of movement x in a first direction and an amount of movement y in a second direction orthogonal to the first direction as the amount of translation and the amount of rotation θ, and
wherein the change extraction section uses derivatives, which are used in the BFGS method at the time of searching for the minimum value of the error function, shown below.
$$\frac{\partial E}{\partial θ} = - 2 {\sum }_{x ∈ χ} Δ I ( \frac{\partial {I}^{n + 1}}{\partial {x}_{n + 1}} \frac{\partial {x}_{n + 1}}{\partial θ} + \frac{\partial {I}^{n + 1}}{\partial {y}_{n + 1}} \frac{\partial {y}_{n + 1}}{\partial θ} ) \\ \frac{\partial E}{\partial {b}_{1}} = - 2 {\sum }_{x ∈ χ} Δ I \frac{\partial {I}^{n + 1}}{\partial {x}_{n + 1}} \\ \frac{\partial E}{\partial {b}_{2}} = - 2 {\sum }_{x ∈ χ} Δ I \frac{\partial {I}^{n + 1}}{\partial {y}_{n + 1}} \\ where \\ Δ I = {I}^{n} ( {x}_{n} ) - {I}^{n + 1} ( {x}_{n + 1} ) \\ {x}_{n + 1} = {x}_{n} cos θ - {y}_{n} sin θ + {b}_{1} \\ {y}_{n + 1} = {x}_{n} sin θ + {y}_{n} cos θ + {b}_{2} \\ \frac{\partial {x}_{n + 1}}{\partial θ} = - {x}_{n} sin θ - {y}_{n} cos θ \\ \frac{\partial {y}_{n + 1}}{\partial θ} = {x}_{n} cos θ - {y}_{n} sin θ \qquad Numerical Expression 1$$

3. The image change extraction device according to claim 1, wherein the image transformation section performs the image transform processing on the first frame image by using the affine transform parameters which further includes a scale of the image.

4. The image change extraction device according to claim 3,
wherein the image transformation section performs the image transform processing by using the affine transform parameters which include an amount of movement x in a first direction and an amount of movement y in a second direction orthogonal to the first direction as the amount of translation, the amount of rotation θ, and a scale z in a zoom direction, and
wherein the change extraction section uses derivatives, which are used in the BFGS method at the time of searching for the minimum value of the error function, shown below.
$$\begin{matrix}\frac{\partial E}{\partial θ} = - 2 {\sum }_{x ∈ χ} Δ I ( \frac{\partial {I}^{n + 1}}{\partial {x}_{n + 1}} \frac{\partial {x}_{n + 1}}{\partial θ} + \frac{\partial {I}^{n + 1}}{\partial {y}_{n + 1}} \frac{\partial {y}_{n + 1}}{\partial θ} ) \\ \frac{\partial E}{\partial {b}_{1}} = - 2 {\sum }_{x ∈ χ} Δ I \frac{\partial {I}^{n + 1}}{\partial {x}_{n + 1}} \\ \frac{\partial E}{\partial {b}_{2}} = - 2 {\sum }_{x ∈ χ} Δ I \frac{\partial {I}^{n + 1}}{\partial {y}_{n + 1}} \\ \frac{\partial E}{\partial z} = - 2 {\sum }_{x ∈ χ} Δ I ( \frac{\partial {I}^{n + 1}}{\partial {x}_{n + 1}} \frac{\partial {x}_{n + 1}}{\partial z} + \frac{\partial {I}^{n + 1}}{\partial {y}_{n + 1}} \frac{\partial {y}_{n + 1}}{\partial z} ) \\ where \\ Δ I = {I}^{n} ( {x}_{n} ) - {I}^{n + 1} ( {x}_{n + 1} ) \\ {x}_{n + 1} = z {x}_{n} cos θ - z {y}_{n} sin θ + {b}_{1} \\ {y}_{n + 1} = z {x}_{n} sin θ + z {y}_{n} cos θ + {b}_{2} \\ \frac{\partial {x}_{n + 1}}{\partial θ} = - z {x}_{n} sin θ - z {y}_{n} cos θ \\ \frac{\partial {y}_{n + 1}}{\partial θ} = z {x}_{n} cos θ - z {y}_{n} sin θ \\ \frac{\partial {x}_{n + 1}}{\partial z} = {x}_{n} cos θ - {y}_{n} sin θ \\ \frac{\partial {y}_{n + 1}}{\partial z} = {x}_{n} sin θ + {y}_{n} cos θ\end{matrix} \qquad Numerical Expression 2$$

5. The image change extraction device according to claim 1, wherein the error function derivation section calculates the square values of the differences between the pixel values of the first transform frame image and the pixel values of the second frame image adjacent to the first frame image at the identical coordinates thereof.

6. The image change extraction device according to claim 1, wherein the error function derivation section independently calculates, in parallel, the respective square values of the differences between the pixel values of the first transform frame image and the pixel values of the second frame image at the respective identical coordinates thereof.

7. The image change extraction device according to claim 1,
wherein the image transformation section sequentially generates the first transform frame image by performing the image transform processing on the latest first frame image among the plurality of frame images constituting the moving image, and
wherein the error function derivation section calculates the square values of the differences between the pixel values of the first transform frame image, which is sequentially generated by the image transformation section, and the pixel values of the second frame image, which is immediately previous to the first frame image, at the identical coordinates thereof.

8. An image correction device comprising:
the image change extraction device according to claim 1; and
a correction section that performs correction processing on the first frame image so as to decrease the difference between the first frame image and the second frame image on the basis of the first frame image and an amount of change which is extracted by the image change extraction device.

9. The image correction device according to claim 8, further comprising an image synthesizing section that synthesizes the first frame image, which is corrected by the correction section, and the second frame image.

10. An image correction device comprising:
the image change extraction device according to claim 8;
a correction section that performs correction processing on the first frame image so as to decrease the difference between the first frame image and the second frame image on the basis of the first frame image and an amount of change which is extracted by the image change extraction device; and
an image synthesizing section that synthesizes the first frame image, which is corrected by the correction section, and the second frame image,
wherein the image change extraction device sets an image, which is synthesized by the image synthesizing section, as the second frame image for next first frame image, and extracts an amount of change of the next first frame image.

11. An image correction device comprising:
the image change extraction device according to claim 1; and
a correction section that performs correction processing on the second frame image so as to decrease the difference between the first frame image and the second frame image on the basis of the second frame image and an amount of change which is extracted by the image change extraction device.

12. The image correction device according to claim 11, further comprising an image synthesizing section that synthesizes the second frame image, which is corrected by the correction section, and the first frame image.

13. An image correction program causing a computer to function as the respective sections of the image correction device according to claim 8.

14. An image change extraction program for causing a computer to execute functions of:
image transformation means for generating a first transform frame image by performing image transform processing on a first frame image among a plurality of frame images constituting a moving image on the basis of affine transform parameters including an amount of translation and an amount of rotation;
error function derivation means for, whenever the image transformation means sets predetermined values respectively in the amount of translation and the amount of rotation and generates the first transform frame image, calculating square values of differences between pixel values of the first transform frame image, which is generated by the image transformation means, and pixel values of a second frame image, which is different from the first frame image among the plurality of frame images constituting the moving image, at identical coordinates thereof, and integrating the square values corresponding to all identical coordinates, in which at least the first transform frame image and the second frame image overlap, so as to derive an error function; and
change extraction means for searching for a minimum value of the error function, which is derived by the error function derivation section, by using a BFGS method, and extracting affine transform parameters, which are obtained at the minimum value of the error function, as an amount of change of the first frame image relative to the second frame image.

15. A recording medium storing an image change extraction program for causing a computer to execute functions of:
an image transformation section that generates a first transform frame image by performing image transform processing on a first frame image among a plurality of frame images constituting a moving image on the basis of affine transform parameters including an amount of translation and an amount of rotation;
an error function derivation section that, whenever the image transformation section sets predetermined values respectively in the amount of translation and the amount of rotation and generates the first transform frame image, calculates square values of differences between pixel values of the first transform frame image, which is generated by the image transformation section, and pixel values of a second frame image, which is different from the first frame image among the plurality of frame images constituting the moving image, at identical coordinates thereof, and integrates the square values corresponding to all identical coordinates, in which at least the first transform frame image and the second frame image overlap, so as to derive an error function; and
a change extraction section that searches for a minimum value of the error function, which is derived by the error function derivation section, by using a BFGS method, and extracts affine transform parameters, which are obtained at the minimum value of the error function, as an amount of change of the first frame image relative to the second frame image.

16. An image correction program causing a computer to function as the respective sections of the image correction device according to claim 11.
